(19) United States
(12) Patent Application Publication
(10) Pub. No.: US 2024/0204180 A1
(43) Pub. Date: Jun. 20, 2024

(54) ANODE BASED ON HYDROGENATED AMORPHOUS SILICON CARBIDE FOR APPLICATION IN LITHIUM-ION BATTERIES

(71) Applicant: Technische Universiteit Delft, Delft (NL)

(72) Inventors: Miroslav ZEMAN, Delft (NL); Olindo ISABELLA, Delft (NL); Rene Adrianus Christianus Marinus Maria VAN SWAAIJ, Delft (NL)

(73) Assignee: Technische Universiteit Delft, Delft (NL)

(21) Appl. No.: 18/555,725

(22) PCT Filed: Mar. 23, 2022
(86) PCT No.: PCT/NL2022/050156

§ 371 Date: Oct. 16, 2023

(30) Foreign Application Priority Data
Apr. 15, 2021 (NL) 2027982

(51) Int. Cl. H01M 4/38; H01M 4/02; H01M 4/04; H01M 4/40; H01M 4/583; H01M 10/0525

(52) U.S. Cl. CPC H01M 4/386; H01M 4/0404; H01M 4/0428; H01M 4/405; H01M 4/583; H01M 10/0525; H01M 2004/021; H01M 2004/027; H01M 2004/028

(57) ABSTRACT

The present invention relates in a first aspect to a battery, typically a secondary cell battery which can be recharged, in a second aspect to a use of an improved anode, such as in the battery, and to a method of producing a battery or anode, the battery comprising a cathode, and in between the cathode and anode an electrolyte. The present invention provides an improved battery, such as in terms of specific capacity.

### FIELD OF THE INVENTION

The present invention relates in a first aspect to a battery, typically a secondary cell battery which can be recharged, in a second aspect to a use of an improved anode, such as in the battery, and to a method of producing a battery or anode, the battery comprising a cathode, and in between the cathode and anode an electrolyte. The present invention provides an improved battery, such as in terms of specific capacity.

### BACKGROUND OF THE INVENTION

The present invention is in the field of a secondary electrochemical cell, commonly referred to as a rechargeable battery. Such a cell is capable of generating electrical energy from chemical reactions or using electrical energy to cause chemical reactions, such as when recharged. The electrochemical cells which generate an electric current are called voltaic cells or galvanic cells and those that generate chemical reactions, via electrolysis for example, are called electrolytic cells. The present invention is focused on galvanic cells, such as a battery. A battery may consist of one or more cells. Cells can be connected in parallel, in series, or a combination thereof. When discharged/recharged such a cell effectively is both a galvanic cell and an electrolytic cell. It is used to store electric energy upon charging, and to deliver electric energy upon discharging.

A lithium-ion battery may be used for energy storage, which may be a type of rechargeable battery. Lithium-ion batteries are widely used, such as for portable electronics, electric vehicles, and electrical energy storage devices. In the batteries, lithium ions may move back and forth, from the negative electrode to the positive electrode during discharge, and vice versa when charging. For rechargeable cells, the term cathode designates the electrode where reduction is taking place during the discharge cycle; for lithium-ion cells, the positive electrode is referred to as cathode, which typically is the lithium-based one. Li-ion batteries may use an intercalated lithium compound as one electrode material. The batteries have certain advantages over other electric energy storage devices, such as a relatively high energy density, low self-discharge, and no memory effect. Typical density characteristics are a specific energy density of up to 250 Wh/kg, a volumetric energy density of up to 2230 J/cm³, and a specific power density of up to 1500 W/kg. Performance of the batteries can be improved, such as in terms of life extension, energy density, safety, costs, and charging speed.

There is an on-going need to improve a capacity, an energy density, prevent ion depletion, charging speed, and cycling performance of power supply units. In addition prior art devices tend to have too many inactive parts and/or too large inactive part. Some of these devices suffer from internal mechanical stress, capacity loss, and shortening of cycle life. In this respect Si could be considered as anode material, but it is often not suited in view of its large volumetric expansion when forming LiₓSi_{y} (such as LiSi_{4.4}).

Li-ion batteries usually consist of a LiCoO₂ cathode and graphite anode. During charging Li ions are transported towards and absorbed by the electrode, typically a graphite electrode, by intercalation of the Li ions in planar atomic graphite structure. The specific capacity of materials used in these batteries is in the order of 372 mAh/g (Ashuri et al., Nanoscale, vol. 8, 74 (2016)). In order to increase the specific capacity other anode materials are investigated. Further examples of such prior art electrodes can be found in US 2014/079997 A1, US 2012/009473 A1, JP 2014 116201 A, Rui et al., and Bullot and Schmidt. US 2014/079997 A1 recites a use of a methylated amorphous silicon alloy as the active material in an anode of Li-ion battery. Lithium storage batteries and anodes manufactured using the material, as well as a method for manufacturing the electrodes by low-power PECVD are also described. US 2012/009473 A1 recites a negative active material for a secondary lithium battery and a secondary lithium battery including the same. The negative active material for a secondary lithium battery includes an amorphous silicon-based compound represented by the Chemical Formula SiAₓH_{y}, wherein A is at least one element selected from C, N, or a combination thereof, 0<x, 0<y, and 0.1≤x+y≤1.5. JP 2014 116201 A recites a negative electrode active material capable of increasing initial coulomb efficiency, which is hydrogenated amorphous silicon comprising a compound containing Si, O, H and N as main constituents. In the compound, the molar ratios of O, H and N relative to Si are 0.05-0.8, 0.01-0.3 and 0.003-0.1, respectively. The compound further may contain inevitable impurities derived from raw materials such as CaSi₂, an acid and a doping agent. In the negative electrode active material, an N concentration in the surface layer part is higher than that in the center part. The negative electrode active material can be obtained by firing layered polysilane in inert gas and doping N into the fired product. Xu et al. (doi/10.1063/6.0000003) recite nitrogen doped hydrogenated amorphous silicon thin films, also recorded as silicon rich hydrogenated amorphous silicon nitride thin films, were deposited by plasma enhanced chemical vapor deposition. The structural evolution and mechanical properties of the films with different nitrogen contents were studied by Fourier transform infrared spectroscopy, Raman scattering spectroscopy, and the density and stress measurement system, respectively. The results showed that with the increase in ammonia gas flow rate from 0.5 SCCM to 20 SCCM, the tensile stress and the density of the films decreased from 600 MPa to 280 MPa and from 2.31 g/cm³ to 2.08 g/cm³, respectively. The hydrogen bonding configurations, hydrogen content, and structural ordering evolution were investigated to reveal the relationship between the structural and mechanical properties of the films. Bullot et al. recite amorphous silicon-carbon alloys (Physics of Amorphous Silicon-Carbon Alloys, October 1987, physica status solidi (b) 143(2):345-418, DOI:10.1002/pssb.2221430202). Silicon has a theoretically much higher specific capacity of 3590 mAh/g (Ashuri et al., Nanoscale, vol. 8, 74 (2016)) if applied in a Li-ion battery. However, during lithiation (the process in which the anode takes up Li ions) the volume of the anode may expand up to 300%, ultimately leading to pulverization of the silicon anode and battery operation ceases. In order to overcome this, porous silicon is used that can accommodate Li ions in the porous structure, albeit at the expense of the specific capacity.

Also SiC composites are considered, but these have limited capacity. In general, loss of contact and rupture of the passivating solid electrolyte interphase (SEI) is a problem, which is found to induce progressive electrolyte decomposition.

The present invention therefore relates to an improved power supply unit, in particular a battery, which solves one or more of the above problems and drawbacks of the prior art, providing reliable results, without jeopardizing functionality and advantages.

### SUMMARY OF THE INVENTION

It is an object of the invention to overcome one or more limitations of power supply units of the prior art and methods of making these and at the very least to provide an alternative thereto. In a first aspect the present invention relates to a battery comprising a cathode, an anode, in between the cathode and anode an electrolyte, characterized in that the anode comprises a silicon alloy (a-Si_{y}Aₓ:Q_{z}), wherein element A is selected from B, C, N, Ge, O, and combinations thereof, wherein element Q is selected from H, F, and combinations thereof, wherein the silicon alloy is porous, wherein the silicon alloy has a porosity from 1-50%, wherein the silicon alloy is amorphous, and wherein the silicon alloy is preferably hydrogenated. The term “porous” is elaborated on somewhat. A porous medium or a porous material is a material containing pores, which may also be referred to as voids. The pores are surrounded by a skeleton, which is often called the matrix. The skeletal material is usually a solid. A porous medium is most often characterised by its porosity. Although many materials are somewhat porous, many are not, or at least, to such an extent that they would not be referred to as porous. For instance, a tube carrying a fluid is better not porous. For that matter, crystalline material is typically not porous, nor are materials such as coatings porous, as they are intended to protect an underlying material from influences of e.g. the environment. Such is also the case for thin films, that are typically not porous. In fact, if thin films would be porous, in general, most semiconductor device would not last long. Such is also in general the case for amorphous materials, that are often used for protection or for forming a barrier. The use of F is found to result in somewhat stronger materials. In addition the anode and/or cathode may be doped, such as with P, As, Al, and B. Said improved battery provides improved characteristics of the battery, such as a specific capacity of >3000 mAh/g (measured by combining the results of discharge measurement and an integration over time thereof and measurement of the difference in mass of the anode before and after deposition using a microbalance), at a C/10 discharge rate, such as >5 times higher than that of graphite, in particular >9 time higher, such as 10 times higher, an increased gravimetric energy >900 Wh/kg, an increased time between battery charging, a reduced weight of the battery, and if applied in a vehicle a reduced weight of said vehicle, an extended travel range of said, or for a combination thereof. It is noted that the overpotential, further optional losses, and the cathode may become a limiting factor in practice, e.g. in terms of gravimetric energy.

The present silicon alloy material is amorphous and porous. The porosity is found necessary for a properly functioning anode in a battery, such as a Lithium Ion Battery (LIB). The porosity may also be considered to relate to the void volume fraction of the present Si-alloy matrix material. Therefore, for application in LIB, control of this porosity is desired when making the anode, and by controlling the deposition conditions, the porosity of amorphous materials is controlled. The silicon alloy material may be hydrogenated/fluorinated, which is due to the production method (Chemical Vapour Deposition=CVD, often Plasma Enhanced). With this method, a layer is deposited from a silica-containing gas (often silane, SiH₄) onto a substrate. Because the gas used is often a silicon-hydrogen compound, hydrogen enters the layer. The hydrogenation is considered not directly necessary for application in a LIB anode. Indeed, inventors could make silicon alloy material without hydrogen by using a different precursor gas which may offer certain advantages. Inventors first investigated an alloy of silicon with carbon (a-SiCₓ:H), which was made by adding CH₄ to the gas during deposition. However, other elements are also of interest and offer certain advantages, such as nitrogen, (N), oxygen (O), germanium (Ge), boron (B), and as mentioned fluorine (F) may be used for fluorinating. Alloying is found particularly important to manage volume expansion. With an “alloy” a whole compositional range is included, i.e. in the formula a-Si_{y}Aₓ:Q_{z} that 0<x<1.

In this invention a method is disclosed to produce anode material that can accommodate Li ions during charging at high specific capacity. For this inventors use an amorphous silicon alloy, such as hydrogenated amorphous silicon carbide (a-SiCₓ:H), that in an example is deposited directly on a current collector (e.g., a carbon fibre paper) using Plasma Enhanced Chemical Vapour Depositions (PECVD). In this aspect it is found that use can be made of any other CVD method. It is found that by changing the deposition settings the composition (silicon-carbon ratio) and the porosity of the material can be tuned. In this way the specific capacity can be controlled at a high level. Inventors consider novel aspects of this invention to relate to the production of a-SiAₓ:Q material in which the porosity and composition of the material can be tuned separately. The effect of this is at least fourfold:
(i) By tuning the porosity of the a-SiAₓ:Q anode it allows the material to absorb electrolyte, such as Li ions, effectively during the process of lithiation, due to the large surface area created by the pores in the material.
(ii) The porous structure allows the material surrounding the pores to expand upon lithiation.
(iii) By tuning the composition of the material surrounding the pores the expansion of this material can be controlled such that the material does not pulverize.
(iv) By deploying a-SiAₓ:Q anode the specific capacity of batteries can be increased by one order of magnitude.

Inventors specifically address the combination of porosity and a SiAₓ matrix. In this way a large surface area is available to absorb electrolyte ions during charging. The porous structure allows the surrounding material to manage the volume change, whilst tuning the composition of this surrounding allows a large fraction of the matrix to engage in the lithiation process without breaking down.

Battery tests have shown that the specific capacity of the a-SiCₓ:H anode can be up to nearly 9 to 10 times higher than current standard graphite anode. This phenomenon is considered to increase the battery performance of Li-ion batteries, for instance, by extending the range of electric vehicles for the same weight of the battery pack, or alternatively reducing the weight of the battery pack for the same range.

Typically the present anode has an open-cell structure.

In a second aspect the present invention relates to a use of the present battery for improving characteristics of the battery, such as for increasing a specific capacity (mAh/g) of a battery, in particular to a specific capacity of >3000 mAh/g, at a C/10 discharge rate, such as >5 times higher than that of graphite, in particular >9 times higher, such as 10 times higher, and/or for increasing a gravimetric energy >900 Wh/kg, for increasing time between battery charging, for reducing weight of a battery, for reducing weight of a vehicle comprising a battery according to the invention, for extending a travel range of a vehicle comprising a battery according to the invention, or for a combination thereof.

In a third aspect the present invention relates to a method of producing the present battery, comprising depositing a hydrogenated amorphous silicon alloy (a-Si_{y}Aₓ:Q_{z}), wherein element A is selected from B, C, N, Ge, 0, and combinations thereof, wherein element Q is selected from H, F, and combinations thereof, such as silicon carbide, on a current collector, in particular using CVD, such as PECVD.

The present invention provides a solution to one or more of the above mentioned problems and overcomes drawbacks of the prior art.

Advantages of the present description are detailed throughout the description.

### DETAILED DESCRIPTION OF THE INVENTION

In an exemplary embodiment of the present battery the cathode and/or electrolyte comprises lithium.

In an exemplary embodiment of the present battery the cathode comprises a material selected from graphite, a Li-metal based alloys, such as Li-metal alloy oxide, such as LiCoO₂, such as Li-metal alloy phosphate, such as LiFePO₄, and combinations thereof.

In an exemplary embodiment the present battery may comprise a current collector.

In an exemplary embodiment of the present battery the anode comprises amorphous silicon alloy a-Si_{y}Aₓ:Q_{z} deposited on the current collector, such as on a carbon fibre paper current collector, preferably hydrogenated and/or fluorinated amorphous silicon alloy.

In an exemplary embodiment of the present battery the mass load is 0.3-12 mg amorphous silicon alloy a-Si_{y}Aₓ:Q_{z} per cm² of the current collector, preferably 0.5-7 mg/cm², more preferably 0.9-5 mg/cm², such as 1-3 mg/cm².

In an exemplary embodiment of the present battery the anode consists/comprises of hydrogenated amorphous silicon carbide a-Si_{y}Cₓ:H_{z} and optionally elementary electrolyte, such as Li.

In an exemplary embodiment of the present battery is with the proviso that the anode does not consist/comprise of hydrogenated amorphous silicon carbide a-Si₃C₄:H.

In an exemplary embodiment of the present battery the anode consists of non-stoichiometric amorphous silicon alloy a-Si_{y}Aₓ:Q_{z}. (measured with EDS) In an exemplary embodiment of the present battery the anode consists of non-stoichiometric hydrogenated amorphous silicon carbide with a formula a-Si_{y}Cₓ:H_{z} wherein y=1 and x is from 0.003-0.25, preferably from 0.005-0.2, such as from 0.1-0.15.

In an exemplary embodiment of the present battery z is from 0.0-2, preferably from 0.1-1.5, such as from 0.2-1.0.

In an exemplary embodiment of the present battery a ratio y:x is from 300:1 to 4:1, preferably from 200:1 to 40:1, more preferably 180:1 to 100:1 such as from 170:1 to 160:1.

In an exemplary embodiment of the present battery a ratio z:y is from 1:0 to 1:2, preferably from 100:1 to 1:1, more preferably 10:1 to 2:1 such as from 5:1 to 4:1.

In an exemplary embodiment of the present battery Si is present in an amount of 60-99.7 atom %, preferably 70-95 atom %, more preferably 72-85 atom %, even more preferably 75-80 atom %.

In an exemplary embodiment of the present battery wherein A is present in an amount of 0.3-30 atom %, preferably 2-25 atom %, more preferably 7-20 atom %, even more preferably 12-17 atom %.

In an exemplary embodiment of the present battery Q is present in an amount of 0.3-30 atom %, preferably 1-15 atom %, more preferably 2-12 atom %, even more preferably 5-10 atom %.

In an exemplary embodiment of the present battery the silicon alloy has a porosity from 3-40%, preferably from 7-25%, such as from 10-15% (obtained by measuring the refractive index using spectroscopic ellipsometry and applying the Bruggemann Effective Medium Approach).

In an exemplary embodiment of the present battery the silicon alloy has a pore size from 3-300 nm, preferably a pore size from 5-200 nm as measured with electron microscopy, more preferably a pore size from 10-100 nm, even more preferably a pore size from 20-50 nm (using vacuum-volumetric, gravimetric adsorption techniques, or molecular simulation techniques, such as with a PoreMaster of Anton Paar).

The present silicon-alloy anode typically has an internal surface area of 1-3000 m²/gr (such as measured with BET, such as with a Macsorb of Mountech).

In an exemplary embodiment of the present battery the silicon alloy is porous to electrolyte, or a species thereof, such as porous to Li-ions.

In an exemplary embodiment of the present battery the silicon alloy has no periodic arrangement over more than five times a Si—Si distance, preferably no periodic arrangement over more than three times a Si—Si distance, such as evidenced by Raman measurement.

In an exemplary embodiment of the present battery the silicon alloy has a width of the silicon transverse optical (TO) peak (FWHM=Full width at half maximum) of 32-44 cm⁻¹ (Raman measurement with Renishaw InVia).

In an exemplary embodiment of the present battery the silicon alloy has for a first order Si—Si interaction virtually no distortion in terms of both distance and angle, hence a constant first order lattice constant, such as with a relative deviation therein of <±5%.

In an exemplary embodiment of the present battery an Raman picture is substantially according to FIG. 5.

In an exemplary embodiment of the present method during deposition a silicon-A ratio y:x is adapted by regulating at least one of ([Si]:[A]), gas composition, flow, substrate temperature, deposition pressure, and RF-power, such as adapting a [Si]:[A] precursor ratio between 4:1 and 1:1, providing a Si-precursor flow of 1-10 sccm, providing a A-precursor flow of 0.2-3 sccm, maintain a substrate temperature between 100-200° C., and RF-power at 13.5 MHz between 3-15 W. In an example a multi-chamber PECVD system referred to as “AMOR” in CR10000 of the Else Kooi Laboratory is used for deposition.

In an exemplary embodiment of the present method during deposition of the hydrogenated or fluorinated amorphous silicon alloy on the current collector the porosity of the silicon alloy is controlled by adapting at least one of ([Si]:[A]), flow, gas composition, substrate temperature, deposition pressure, and RF-power, such as adapting a [Si]:[A] precursor ratio between 4:1 and 1:1, providing a Si-precursor flow of 1-10 sccm, providing an A-precursor flow of 0.2-3 sccm, maintain a substrate temperature between 100-200° C., and RF-power at 13.5 MHz between 3-15 W. Lower RF-powers, as well as higher amounts of precursor of A are found to result in better material characteristics. From the experiments below it follows that the amount of precursor A can be limited.

The invention will hereafter be further elucidated through the following examples which are exemplary and explanatory of nature and are not intended to be considered limiting of the invention. To the person skilled in the art it may be clear that many variants, being obvious or not, may be conceivable falling within the scope of protection, defined by the present claims.

### FIGURES

FIG. 1. Porosity as a function of carbon concentration.

FIG. 2. Specific capacity as a function of cycle numbers for HM-Coin-cell P0.29 C0.7% [P=porosity; C=carbon content], HM-Coin-cell P0.12 C0.6%, HM-Coin-cell P0.33 C7.2%, and HM-Coin-cell P0.39.

FIG. 3. Coulombic efficiency for HM-Coin-cell P0.29 C7.0%, HM-Coin-cell P0.12 C0.6%, HM-Coin-cell P0.33 C7.2%, and HM-Coin-cell P0.39 C16.1%. Based on the equations for error propagation, the error margin for the above mentioned four samples is 8.20%, 7.92%, and 8.34%, and 7.54% respectively.

FIG. 4A. SEM images of carbon fiber before deposited with Si/C composites.

FIG. 4B. SEM images of carbon fiber after deposited with Si/C composites.

FIG. 4C. Schematic illustration of the coin-cell half-cell structure.

FIG. 5: Raman measurement of present anode.

### EXPERIMENTS

In this work, all a-SiCₓ:H samples were deposited by Plasma-Enhanced Chemical Vapor Deposition (PECVD) in DPC (deposition chamber) 2 and DPC 4 of AMOR multi-chamber system in Cleanroom 10000 of the Else Kooi Laboratory (EKL).

Substrates were cleaned and placed on a metal holder. Together they were placed inside the deposition chamber and were connected to the ground electrode, the powered electrode is beneath the ground electrode in parallel. Source gases are injected into the chamber from the bottom left and exhaust gases are pumped out from the bottom right after the reaction. A throttle valve is used to control the pressure in the deposition chamber during processing. When source gases are injected into the chamber and the pressure has stabilized, a spark ignites the gases into a plasma that consists of a complex mixture of ions, radicals, atoms, and electrons.

These plasma products then react on the surface of the substrates, and the growth of the film starts.

### AMOR PECVD Reaction Set Up

There are in total 5 deposition chambers on the AMOR deposition system, of which chamber 1-4 are for a specific deposition type (n-type, p-type, intrinsic, novel materials), and chamber 5 is a flipping chamber.

### Deposition Strategy and Conditions

A series of deposition was conducted under different RF power P and methane flow fraction, R=φ(CH₄)/[φ(CH₄)+φ(SiH₄)], where φ(CH₄) and φ(SiH₄) is the flow rate of methane and silane respectively, both in standard cubic centimetre per minute (sccm). In total, 30 samples were synthesized by varying the power between 3 W, 6 W, 9 W, 12 W and 15 W, and varying the methane flow fraction in different values of R=0, 0.1, 0.3, 0.5, 0.7, 0.9, respectively.

The properties of samples were determined by many factors such as methane flow fraction, deposition power, and other deposition parameters. By varying the methane flow fraction, R, carbon concentration can be controlled. When all other deposition parameter remains constant, a higher methane flow fraction results in a higher carbon concentration in the sample. Of course, by influencing the carbon concentration, the structure of a-SiCₓ:H can also be changed. By varying the deposition power density, P, the structure of a-SiCₓ:H samples, such as porosity can be effectively changed. The flow of CH₄ and SiH₄ was 40 sccm, that of PH₃ 11 sccm, the chamber pressure was 0.7 mbar, and the substrate temperature 180° C. PH₃ (2% diluted in H₂) was used to make the sample n-type doped, this was to increase the electrical conductivity of the anode and at the same time, the capacity retention ability can also be improved to some extent by n-type doping, comparing to p-type Si and undoped. Due to the low reaction temperature of PECVD, substrates can be kept at a temperature of 180° C., which favours the formation of the amorphous structure.

Initially, Provac Pro500S located in the cleanroom 10000, EKL, was used to deposit a thin layer of Ti on Asahi glass, for synthesizing pouch-cells in the battery tests. Both E-beam evaporation and thermal evaporation modes are available on this equipment. Thermal evaporation is more suitable for source metal with lower melting points such as Al and Cu. Al was not chosen because it tends to be unstable under a low potential environment, which is usually the case for the anode. Copper was not an option for the obvious reason that it is deep contamination for semiconductors, even though it is suitable for this work, it might pollute colleagues' work in the cleanroom. In this work, E-beam evaporation was applied to deposit a 100 nm thick Ti layer on Asahi glass.

In this work, deposited a-SiCₓ:H films are very thin, with a thickness of around 1-3 μm. Thus when using PECVD, films have to be deposited on a substrate. Different types of substrates were used for different purposes. In total, four types of substrates were used: Corning glass and Si wafer are mainly used for material characterization, and Asahi glass substrates and carbon fibre paper (CFP) substrates were used for battery tests a-SiCₓ:H films deposited on Asahi glass or CFP can be assembled into pouch cells or coin cells, respectively. Glass and Si substrates, as well as Asahi glass substrates and carbon fiber paper (CFP) substrates, were use initially.

Battery tests were performed for chosen samples deposited at the earlier stage of the work, mainly aiming to find out how the battery performances, more precisely, how the specific capacity, initial coulombic efficiency, and capacity retention ability are affected by material properties such as porosity and carbon concentration. It is worth mentioning that in a lithium ion battery consists of a cathode and an anode and whichever material has a lower potential comparing to Li/Li⁺ will be the anode. a-SiCₓ:H is referred to as the anode in the previous sections because, in a commercialized battery, the counter electrodes are usually different types of metal oxides, such as Lithium Nickel Cobalt Aluminium Oxide (NCA) or Lithium Cobalt Oxide (LiCoO₂). Those oxides have a potential of around 4 V vs Li/Li⁺, while this value for a-SiCₓ:H is 0.4 V, which is significantly lower and essentially makes it the anode of the battery. In this work, however, half-cell tests were performed to investigate the properties and performance of the anode material of interests. In a half-cell battery test, the counter electrode is a thin lithium metal foil, which has 0 V potential vs Li/Li⁺ and this effectively makes the a-SiCₓ:H the cathode. This means just the terminology of anode and cathode are reversed; nothing has changed regarding the electrode reactions and the capacity fade mechanisms of the electrode.

Initial tests were performed on Asahi glass purchased from Asahi Glass Co., Ltd. It has a 1 mm thick glass layer, which serves as the mechanical support. On top of the glass is a layer of 700 nm thick Fluorine-doped tin oxide (FTO), this layer was used to increase the adhesion between the metal layer that was going to be deposited next and the glass. Also, the FTO coating is conductive and can help to carry the current. A 100 nm Ti layer deposited by Provac Pro500S.

Next carbon fibre paper was used as a substrate. Spectracarb GDL 0550 carbon fiber paper is made of carbon fibers that are connected by resin, as can be seen from FIGS. 4A, 4B. This material is stable up to 400° C. In order to avoid cross-contamination, deposition on carbon fiber paper was carried out in DPC4 of the AMOR system, as we did not have information on the possible outgassing under vacuum conditions for this material. The use of this material as the substrates has many advantages: 1. Carbon fiber paper is conductive, there will be no need for an additional layer of metal as the current collector. 2. a-SiCₓ:H thin films stick better on carbon fiber paper than on metal, where obvious exfoliation can be observed. 3. Carbon fiber paper is easy to tailor into the desired size and shape and can be assembled into a coin cell conveniently. Deposited films can then be assembled into a coin-cell, the schematic illustration of which can be seen in FIG. 4C.

Scanning Electron Microscopy (SEM) and Energy Dispersive x-ray Spectroscopy (EDS) have been used to characterize the carbon concentration in deposited a-SiCₓ:H. In this work, SEM combined with EDS was performed with a Thermo Fisher® Helios G4 PFIB UXe dual beam combined with an Ametek® (EDAX) Octane Elite Plus (30 mm², 125 eV) detector using TEAM™ Pegasus Integrated EDS-EBSD data acquisition suite. The beam energy employed was 5 keV with a beam current of 2.3 nA.

After deposition, each sample deposited on glass substrates was characterized by Spectroscopic Ellipsometry (SE) for thickness, bandgap (Eg), and refractive index (n) at the far-infrared region. In this work, J.A Woollam M2000DI was used. It covers a wavelength range of 193-1690 nm, with 690 wavelengths options, with a data acquisition rate of 0.05 seconds and the maximum thickness can be measured is 18 mm. In this case, the fitted thickness for the deposited thin film is 88.67 nm, bandgap 1.595 eV and the refractive index is 4.178, each data is within an error margin. In this measurement the mean square error (MSE) is 3.272, which was very low, indicating the measurement is trustworthy.

To quantify the porosity of a-SiCₓ:H, Bruggeman's effective medium approach [G. A. Niklasson, C. G. Granqvist, and O. Hunderi, “Effective medium models for the optical properties of inhomogeneous materials,” Appl. Opt., 1981.] was applied.

The electrical conductivity of deposited a-SiCₓ:H film was measured using dark conductivity measurement. In this work, Keithley 6517B Electrometer/High Resistance Meter was used to measure the conductivity dependence on temperature. An optical microscope was used to connect the contacts with the Al contact layer that was deposited on top of the a-SiCₓ:H. Samples were annealed before measurements. From the measurements, the resistance of the film can be directly obtained, from which the conductance can be calculated. Given the geometrical parameters of the film (in this case, the distance between the two contacts is 0.5 mm and the thickness of the film is 500 nm), the conductivity of the sample can be obtained.

### Porosity as a Function of Carbon Concentration

The relationships between carbon concentration and refractive index, refractive index and porosity have been obtained, the relationship between the porosity and the carbon concentration for each sample can be derived. This relationship is shown in FIG. 1. It can be seen that the porosity of the deposited film increased with a higher carbon concentration and deposition power. Using FIG. 1 allows the influence of porosity and carbon concentration on the performance of the battery to be disentangled. For example, in FIG. 1 two samples with the same carbon concentration but different porosity, or with the same porosity but different carbon concentration can be chosen. By comparing the battery performance between those samples, the role of porosity and carbon concentration can thus be investigated separately. We can see that in the low carbon concentration region (carbon concentration from 0% to 5%), a slight change in carbon concentration results in significant changes in porosity, while at higher carbon concentration region (carbon concentration from 5% to 20%), the porosity does not vary so strongly with carbon concentration.

The trend shows that all curves could be intersecting near 17% carbon concentration, 40% porosity. The difference between each curve could be more pronounced at even higher carbon concentration region, however, a higher carbon concentration may require changes in other deposition parameters, such as a higher chamber pressure or a higher temperature.

Specific Capacity for Samples with High Mass Load

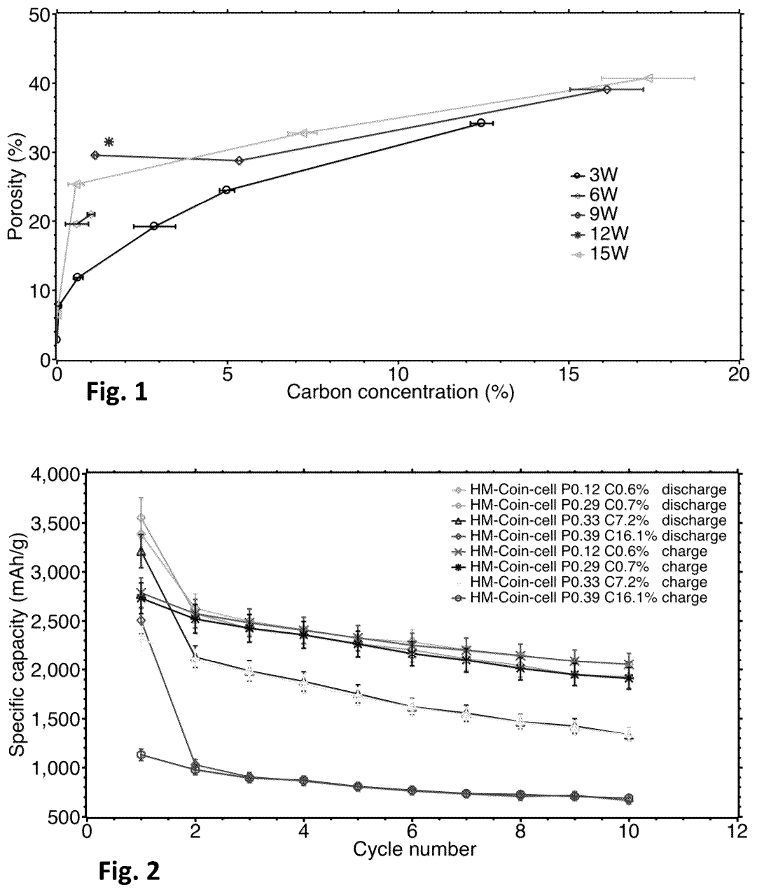

Specific capacity has been calculated. The results are shown in FIG. 2. It can be seen 4 samples showed a very pronounced difference in the specific capacity. By comparing the specific capacity for HM-Coin-cell P0.29 C0.7% and HMCoin-cell P0.12 C0.6%, which have similar carbon concentration but a big difference in porosity, it can be seen that a higher porosity leads to a slightly higher capacity. This might be explained by realizing that a large surface area comes with the higher porosity, enhancing the electrode reaction kinetics.

By comparing the specific capacity of HM-Coin-cell P0.29 C0.7%, HM-Coin-cell P0.33 C7.2%, and HM-Coin-cell P0.39 C16.1%, which have similar porosity but a very big difference in carbon concentration, it can be clearly seen how the increase in the carbon concentration leads to a lower capacity. This is simply due to a lower silicon content.

For samples with higher mass load, the deposition area is 15 cm². The error margin of the mass measurements of HM-Coin-cell P0.12 C0.6% (1.19±0.07 mg/cm²), HM-Coin-cell P0.29 C0.7% (1.15±0.07 mg/cm²), HM-Coin-cell P0.33 C7.2% (1.13±0.07 mg/cm²), and HM-Coin-cell P0.39 C16.1% (1.25±0.07 mg/cm2) is calculated to be 5.60%, 5.80%, 5.90% and 5.33%, respectively.

Coulombic Efficiency for Samples with High Mass Load

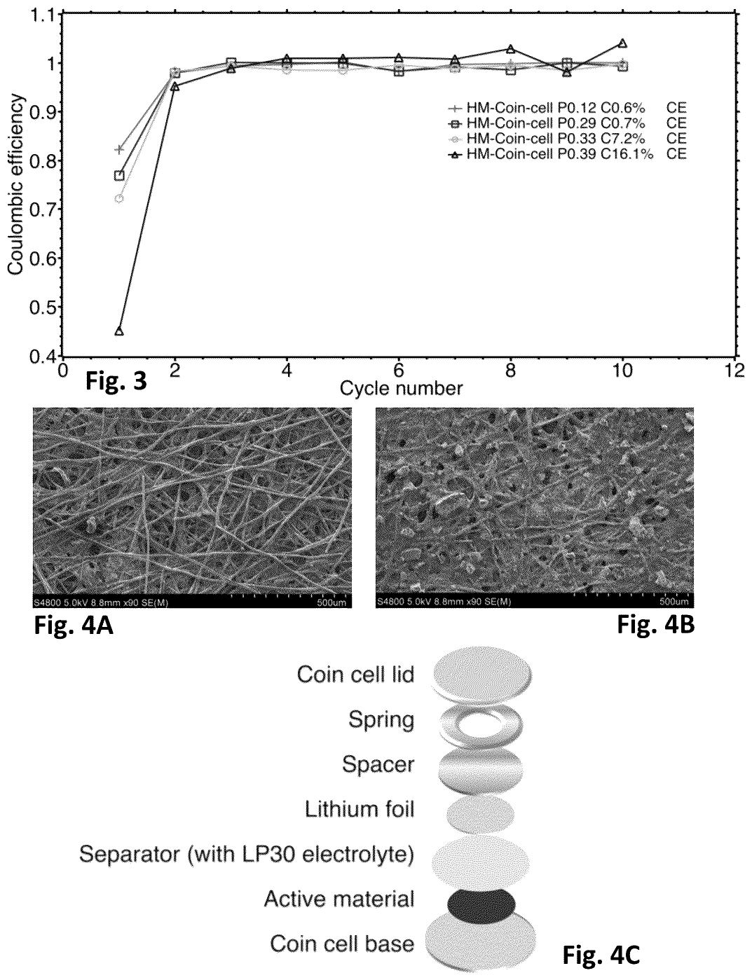

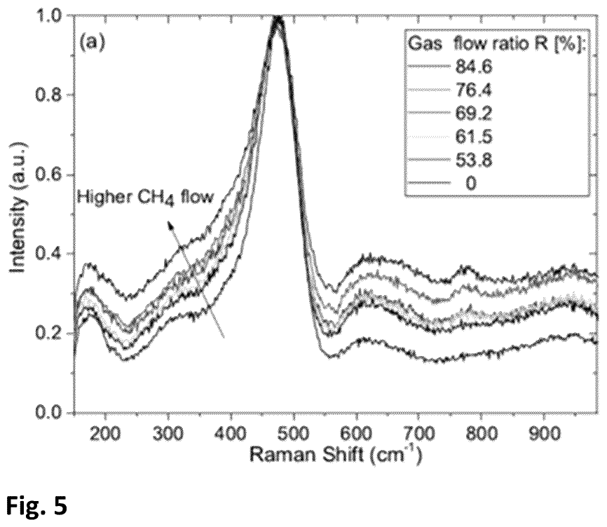

Coulombic efficiency can also be compared between samples with high mass load. As can be seen in FIG. 3, the Coulombic efficiency for all samples reaches 100% after 2 cycles, but they show some differences in initial Coulombic efficiency. A clear trend can be seen that initial Coulombic efficiency decreases with an increase in carbon concentration. This can be explained by the higher carbon concentration favours the reaction between carbon and Li+ ions.

For experimental results reference is made to the MSc thesis of Shihao Wang of the TU Delft, with title “Study of n-type Amorphous Silicon Alloy as the Anode in Li-ion Batteries”, which thesis and its contents are incorporated by reference.

1. A battery comprising
a cathode,
an anode,
in between the cathode and anode an electrolyte,
characterized in that
the anode comprises a silicon alloy (a-Si_{y}Aₓ:Q_{z}), wherein element A is selected from B, C, N, Ge, O, and combinations thereof, wherein element Q is selected from H, F, and combinations thereof, wherein the silicon alloy is porous for accommodating electrolyte ions, such as Li ions,
wherein the silicon alloy has a porosity from 1-50%, wherein the silicon alloy is amorphous.

2. The battery according to claim 1, wherein the cathode and electrolyte comprises lithium.

3. The battery according to claim 1, wherein the cathode comprises a material selected from graphite, Li-metal based alloys, and combinations thereof.

4. The battery according to claim 1, comprising a current collector, and wherein the anode comprises amorphous silicon alloy a-Si_{y}Aₓ:Q_{z} deposited on the current collector, and
wherein the mass load is 0.3-12 mg amorphous silicon alloy a-Si_{y}Aₓ:Q_{z} per cm² of the current collector, and
wherein a thickness of a silicon alloy a-Si_{y}Aₓ:Q_{z} is 0.5-3 μm.

5. The battery according to claim 1, wherein the anode consists/comprises of hydrogenated amorphous silicon carbide a-Si_{y}Cₓ:H_{z} and elementary electrolyte, and with the proviso that the anode does not consist/comprise of hydrogenated amorphous silicon carbide a-Si₃C₄:H.

6. The battery according to claim 1, wherein the anode consists of non-stoichiometric amorphous silicon alloy a-Si_{y}Aₓ:Q_{z}.

7. The battery according to claim 6, wherein the anode consists of non-stoichiometric hydrogenated amorphous silicon carbide with a formula a-Si_{y}Cₓ:H_{z} wherein y=1 and x is from 0.003-0.25, and
wherein z is from 0.0-2.

8. The battery according to claim 6, wherein a ratio y:−x is from 300:1 to 4:1, and
wherein a ratio z:−y is from 1:0 to 1:2, and
wherein Si is present in an amount of 60-99.7 atom % and
wherein A is present in an amount of 0.3-30 atom % and
wherein Q is present in an amount of 0.3-30 atom %.

9. The battery according to claim 1, wherein the silicon alloy has a porosity from 3-40%, obtained by measuring the refractive index using spectroscopic ellipsometry and applying the Bruggemann Effective Medium Approach, and
wherein the silicon alloy has a pore size from 3-300 nm as measured with electron microscopy, and
wherein the silicon alloy is porous to electrolyte, and
wherein the silicon alloy has no periodic arrangement over more than five times a Si—Si distance and
wherein the silicon alloy has a width of the silicon transverse optical (TO) peak (FWHM=Full width at half maximum) of 32-44 cm⁻¹ (using Raman measurement), and
wherein the silicon alloy has for a first order Si—Si interaction virtually no distortion in terms of both distance and angle.

10. (canceled)

11. A method of producing a battery comprising a cathode, an anode, in between the cathode and anode an electrolyte, characterized in that the anode comprises a silicon alloy (a-Si_{y}Aₓ:Q_{z}), wherein element A is selected from B, C, N, Ge, O, and combinations thereof, wherein element Q is selected from H, F, and combinations thereof, wherein the silicon alloy is porous for accommodating electrolyte ions, such as Li ions, wherein the silicon alloy has a porosity from 1-50%, wherein the silicon alloy is amorphous, the method comprising
depositing an amorphous silicon alloy (a-Si_{y}Aₓ:Q_{z}), wherein the silicon alloy has a porosity from 1-50%, wherein element A is selected from B, C, N, Ge, O, and combinations thereof, wherein element Q is selected from H, F, and combinations thereof on a current collector, using CVD.

12. The method according to claim 11, wherein during deposition a silicon-A ratio y:x is adapted by regulating at least one of precursor ratio ([Si]:[A]), flow, gas composition, substrate temperature, deposition pressure, and RF-power.

13. The method according to claim 11, wherein during deposition of the amorphous silicon alloy selected from hydrogenated and fluorinated amorphous silicon alloy on the current collector the porosity of the silicon alloy is controlled by adapting at least one of a precursor ratio ([Si]:[A]), gas composition, flow, substrate temperature, deposition pressure, and RF-power.

14. The battery according to claim 1, wherein the silicon alloy is hydrogenated.

15. The battery according to claim 1, wherein the silicon-alloy anode has an internal surface area of 1-3000 m²/gr.

16. The battery according to claim 1, wherein the silicon alloy comprises a Si-alloy matrix material, and wherein the porosity is the void volume fraction of said matrix material.
